(19) United States
(12) Patent Application Publication
(10) Pub. No.: US 2026/0169982 A1
(43) Pub. Date: Jun. 18, 2026

(54) QUERY- AND MODEL-AWARE FEW-SHOT PROMPTING

(71) Applicant: Pryon Incorporated, Raleigh, NC (US)

(72) Inventors: Ellen Eide Kislal, Leawood, KS (US); Chul Sung, Hackensack, NJ (US); Vaibhava Goel, Chappaqua, NY (US); Steven John Rennie, Yorktown Heights, NY (US); David Nahamoo, Great Neck, NY (US)

(21) Appl. No.: 19/530,805

(22) Filed: Feb. 5, 2026

Related U.S. Application Data
(63) Continuation of application No. PCT/US2025/033819, filed on Jun. 16, 2025.
(60) Provisional application No. 63/659,994, filed on Jun. 14, 2024.

(51) Int. Cl. G06F 16/242

(52) U.S. Cl. CPC G06F 16/243

(57) ABSTRACT

A method for forming a prompt for use with a large language model includes receiving an input query, generating query augmentation data relevant to the query, wherein the query augmentation data includes one or more examples of queries and respective responses, wherein the query augmentation data is selected based on the input query, wherein the selecting of the query augmentation data is further based on characteristics of the large language model, and forming the prompt by combining the input query with the query augmentation data.

### CROSS-REFERENCES TO RELATED APPLICATIONS

This application is a continuation of PCT Application No. PCT/US2025/033819, filed Jun. 16, 2025, which claims the benefit of U.S. Provisional Application No. 63/659,994, filed on Jun. 14, 2024, the entire contents of which are incorporated herein by reference.

### BACKGROUND OF THE INVENTION

This invention relates to prompting large language models.

Large language models (LLMs) can perform a wide range of language tasks, but often perform poorly in specific domains. Adapting LLMs to specific domains often requires fine-tuning, which is resource-intensive and often impractical. As an alternative, prompts can be augmented with relevant context at runtime to guide the model's output.

By including domain-specific or task-specific information directly in the prompt, the accuracy and relevance of responses can be improved without modifying the underlying model. This approach offers a lightweight, flexible way to customize LLM behavior without the need for retraining.

### SUMMARY OF THE INVENTION

Few-shot prompting is a technique used in the context of large language models that enables the model to perform specific tasks or generate specific types of content with minimal examples or “shots” of training data. By providing a small amount of training data in the form of examples (e.g., question-answer pairs) in the prompt, the model can quickly adapt to new tasks or contexts.

In some aspects, few-shot examples are static; once chosen they are used for all queries in a given domain or task. In other aspects, referred to as query-aware few-shot prompting, the examples in the prompt are selected based on their semantic nearness to the query to assist the model by providing few-shot examples that are more relevant.

In yet other aspects, the examples in the prompt are designed to be relevant to the large language model. For example, if the few-shot examples to be included in the prompt are chosen to be easily handled by the model, even in a zero-shot setting, then those examples are less informative to the model than examples that the model would not be able to handle in a zero-shot manner. Aspects described herein are related to a “model-aware”′ approach, in which the selection of few-shot examples is restricted to a pool of training data pairs that were incorrectly handled by the model when running in a zero-shot, inference mode on the training set. From this restricted set, the most similar examples to the query are chosen based on a retriever model, thereby ensuring that the examples are both relevant and informative for a given test query.

In one aspect, a method is configured to form a prompt based on a query in a way that is few-shot prompting model aware. For example, the prompt is formed to include only examples that include questions the model would incorrectly handle in a zero-shot setting. The examples may also be query aware, in that they are chosen to be relevant to the current query. In some aspects, when there are multiple examples in the prompt, the examples are chosen to be distinct from each other to ensure that they provide unique pieces of evidence to the model. In some aspects, an iterative process iteratively selects the top example and then re-calculates the error pool taking the top example into account by doing a 1-shot run over the training data. That pool is then used to select the second example based on proximity to the query. This re-calculation of the error pool from which to select can be iterated over in order to select N examples.

Importantly, the techniques described herein are not merely abstract mental processes or simple information retrieval schemes. The selection of few-shot examples based on both query relevance and model-specific error characteristics involves computational steps that would be infeasible for a human to perform mentally or manually. For example, determining which training examples are mishandled by a large language model in a zero-shot setting, and then selecting the most relevant among those examples relative to a new query, requires executing the model over a large dataset and calculating semantic distances using high-dimensional embeddings. This process is tightly coupled with the behavior and architecture of the underlying model, and is inherently rooted in computer-specific operations that go beyond mere data organization or logic. As such, the disclosed method reflects a specific and practical application of machine learning techniques to improve inference-time performance of large language models without retraining.

In a general aspect, a method for forming a prompt for use with a large language model includes receiving an input query, generating query augmentation data relevant to the query, wherein the query augmentation data includes one or more examples of queries and respective responses, wherein the query augmentation data is selected based on the input query, wherein the selecting of the query augmentation data is further based on characteristics of the large language model, and forming the prompt by combining the input query with the query augmentation data.

Aspects may include one or more of the following features:

The method may include receiving a response by processing the prompt using the large language model. Selecting the augmentation data based on characteristics of the large language model may include training an augmentation data selection model to identify query-response pairs according to predicted responses to the queries by the large language model. Selecting the query augmentation data may include selecting query-response pairs where the query is semantically similar to the input query.

The query augmentation data may be selected using a retriever model trained to compute similarity scores between the input query and queries in a training data set. The selecting of the query augmentation data may include determining a measure of semantic similarity between the input query and each query in training data pairs of a set of available training data, ranking the training data pairs based on the determined measure of semantic similarity, and selecting a predetermined number of training data pairs according to their measures of semantic similarity. The query augmentation data may include only examples for which the large language model failed to produce a correct response in a zero-shot inference setting. The selection of the query augmentation data may include identifying examples with answer formats or structures that the large language model has previously misgenerated in similar contexts.

The large language model may be selected from the group consisting of GPT-4, Claude, PaLM, LLaMA, Mistral, and fine-tuned variants thereof. When there are multiple examples in the prompt, the examples may be selected to be distinct from each other to ensure they provide unique pieces of evidence to the large language model. The selection of the query augmentation data may be performed using an iterative process that iteratively selects a top example and recalculates an error pool from which subsequent examples are selected. Recalculating the error pool may include performing a 1-shot run over the training data, taking the top example into account.

In another general aspect, a system for forming a prompt for use with a large language model includes an input for receiving an input query and one or more processors configured to generate query augmentation data relevant to the input query. The query augmentation data includes one or more examples of queries and respective responses, the query augmentation data is selected based on the input query, and the selecting of the query augmentation data is further based on characteristics of the large language model. The processors are further configured to form the prompt by combining the input query with the query augmentation data.

In another general aspect, software tangibly embodied on a non-transitory computer-readable medium and including instructions that, when executed by a processor, cause the processor to perform a method for forming a prompt for use with a large language mode. The method includes receiving an input query and generating query augmentation data relevant to the input query. The query augmentation data includes one or more examples of queries and respective responses, is selected based on the input query, and the selecting of the query augmentation data is further based on characteristics of the large language model. The prompt is formed by combining the input query with the query augmentation data.

Among other advantages, aspects described herein increase the accuracy of an LLM's responses to queries by providing examples (question/answer pairs) that teach the model how to answer questions in the context of the queries.

Other features and advantages of the invention are apparent from the following description, and from the claims.

### BRIEF DESCRIPTION OF THE DRAWINGS

FIG. 1 is a question answering system.

FIG. 2 is an example of a training data processor.

FIG. 3 is another example of a training data processor.

FIG. 4 is an execution accuracy table.

FIG. 5 is query completion accuracy table.

### DETAILED DESCRIPTION

### 1 Overview

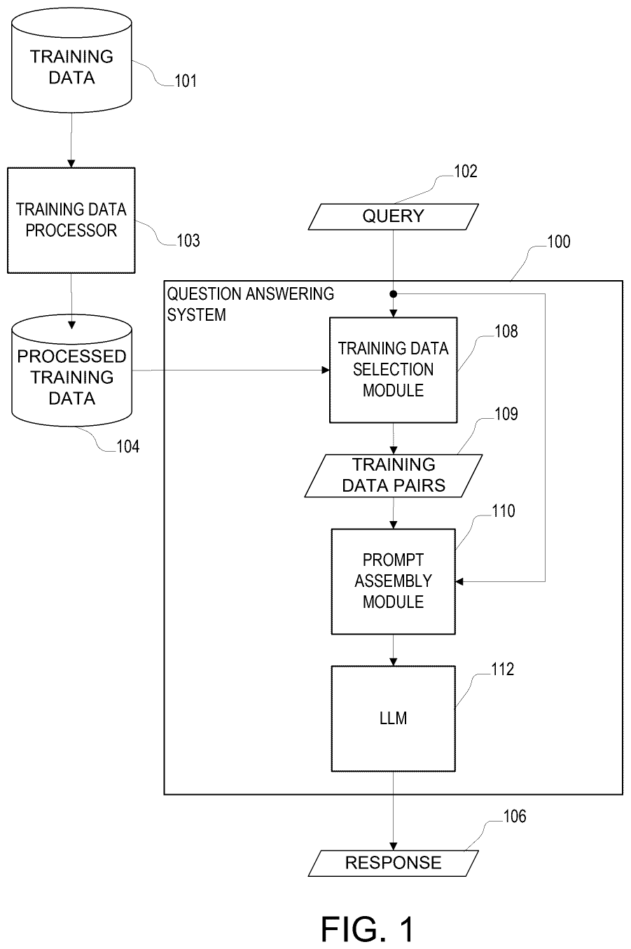

Referring to FIG. 1, a question answering system 100 receives a query 102 (e.g., from a user, not shown) and processes the query according to processed training data 104 to generate a response 106 for presentation to the user. Very generally, the system 100 improves the accuracy of responses generated by a large language model (LLM) by selecting and including in-context examples that the LLM is known to struggle with. Given a database of question-and-answer pairs related to a specific query task, the system prioritizes examples that (1) the LLM answers incorrectly and (2) are semantically similar to the query for inclusion in the prompt alongside the user's query. This approach, called query- and model-aware few-shot prompting, ensures that the examples used in the prompt are relevant to the query and provide corrective guidance where the model needs it most, rather than repeating examples it already handles well. Doing so improves the relevance and reliability of the generated response.

### 2 Processed Training Data

The processed training data 104 is generated by processing training data 101 in a training data processor 103. The training data 101 includes training data pairs, each training data pair including a query (referred to herein as xₜ), and corresponding correct response (referred to herein as yₜ). In one example, the training data processor 103 selects only training data pairs from the training data 101 that include queries that an LLM cannot correctly respond to for inclusion in the processed training data 104. In other examples, the training data processor 103 preserves all the training data pairs from the training data 101, and associates each with information related to how correctly the LLM responded to the query of the pair.

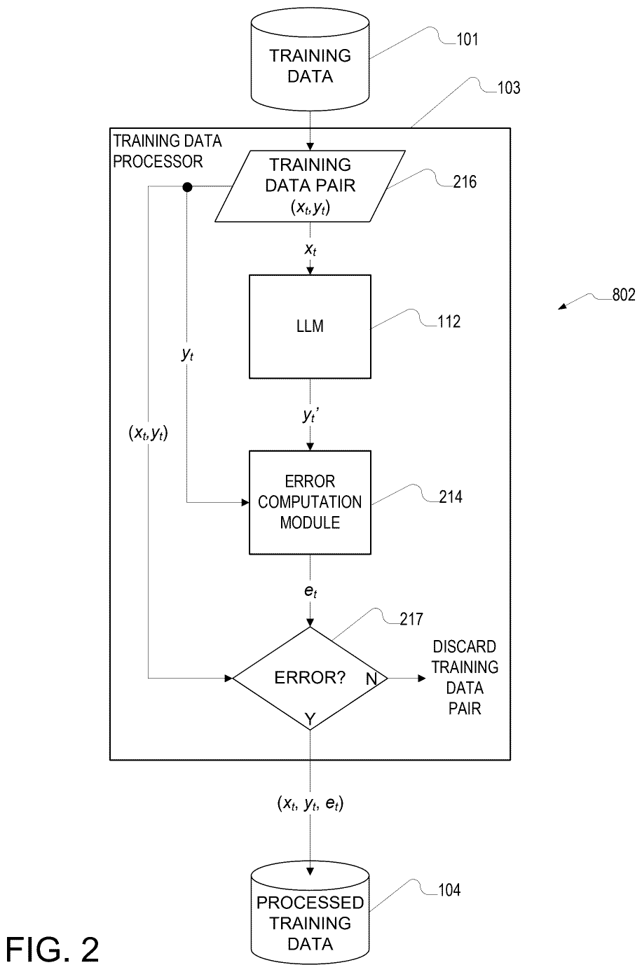

For example, referring to FIG. 2, the training data processor 103 includes an LLM 112, an error computation module 214, and an error analysis module 217.

The training data processor 103 processes each training data pair 216 in the training data 101 using the LLM 112 to determine whether the LLM is able to reproduce the correct response, yₜ from the query, xₜ, of the training data pair 216 in a zero-shot manner. If the LLM 112 can produce the correct (or substantially correct) response, then the training data pair 216 is discarded because the training data pair provides little or no new information to the LLM. On the other hand, if the LLM 112 cannot produce the correct (or substantially correct) response, then the training data pair 216 is added to the processed training data 104 because the training data pair provides new information to the LLM.

In particular, each training data pair 216 is read by the training data processor, and its query, xₜ is extracted and provided to the LLM 112, which generates a response, yₜ′. The response, yₜ′ is provided as input to the error computation module 214, determines whether the response, yₜ′ generated by the LLM 112 sufficiently matches the correct response, yₜ from the training data pair 216. The error can be determined in many different ways, dependent on the query task. For example, the queries could be natural language explanations of desired database operations and the responses would SQL code corresponding to the desired database operations. In that case, the error computation module 214 might compare the SQL code output or even compare the execution results of the two different pieces of code (i.e., because the same result can often be achieved with different code). In another example, the queries could be a partial natural language queries (e.g., xₜ=“What else?”), the responses would be expanded queries (e.g., yₜ=“What else does a technical sergeant do?” and yₜ′=“What else is one to do?”). In that case, the error computation module 214 could use measures of semantic similarity or word distance measures to determine an error between the two responses.

Ultimately, the error computation module generates an error value, et. In some examples the error value, et is a simple flag (e.g., incorrect or correct). In other examples, it can be a measure of correctness (e.g., a confidence score or a probability that the language model failed to produce a correct response in the zero-shot setting).

The error value, et and the training data pair 216 are provided as input to the error analysis module 217. In the case that the error value is a flag, the error analysis module 217 discards any training data pairs where flag indicates “no error” and saves any training data pairs where the flag indicates “error” to the processed training data 104. In the case that the error value, et is a measure of correctness, the error analysis module 217 compares the error value to a predetermined correctness threshold and discards any training data pairs where the measure of correctness exceeds the threshold. Training data pairs where the measure of correctness is below the threshold are saved to the processed training data 104 (sometimes along with the measure of correctness).

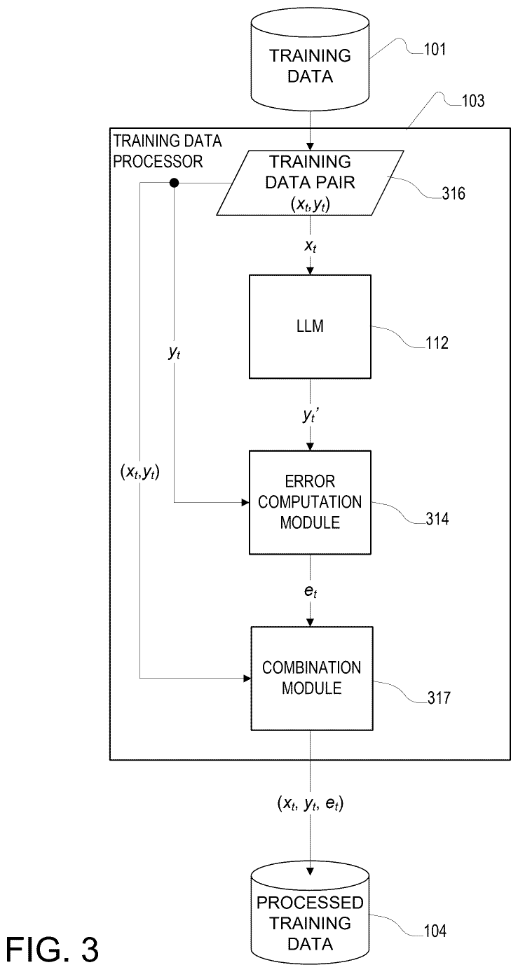

Referring to FIG. 3, in another example, the training data processor 103 includes the LLM 112, an error computation module 314, and a combination module 317.

The training data processor 103 processes each training data pair 316 in the training data 101 using the LLM 112 to determine whether the LLM is able to reproduce the correct response, yₜ from the query, xₜ of the training data pair 316 in a zero-shot manner.

Each training data pair 316 is read by the training data processor, and its query, xₜ is extracted and provided to the LLM 112, which generates a response, yₜ′. The response, yₜ′ is provided as input to the error computation module 314, which determines whether the response, yₜ′ generated by the LLM 112 sufficiently matches the correct response, yₜ from the training data pair 316. An error between the two can be determined in many different ways, dependent on the query task. For example, the queries could be natural language explanations of desired database operations and the responses would SQL code corresponding to the desired database operations. In that case, the error computation module 314 might compare the SQL code output or even compare the execution results of the two different pieces of code (i.e., because the same result can often be achieved with different code). In another example, the queries could be a partial natural language queries (e.g., xₜ=“What else?”), the responses would be expanded queries (e.g., yₜ=“What else does a technical sergeant do?” and yₜ′=“What else is one to do?”). In that case, the error computation module 314 could use measures of semantic similarity or word distance measures to determine an error between the two responses.

Ultimately, the error computation module generates an error value, et, which, in some examples, is a measure of correctness (e.g., a confidence score or a probability that the language model failed to produce a correct response in the zero-shot setting). The error value, et and the training data pair 216 are provided the combination module 317, where the training data pairs are combined with error value, et and saved to the processed training data 104.

### 3 Question Answering System

Referring again to FIG. 1, in some examples, the question answering system 100 includes a training data selection module 108, a prompt assembly module 110, and an LLM 112 (e.g., substantially the same LLM as is used in FIGS. 2 and 3).

The query 102 (referred to herein as xᵢ) is first provided to the training data selection module 108, which processes the query 102 according to the processed training data 104 to select one or more training data pairs 109. Very generally, the training data selection module 108 selects the training data pairs in a way that is both query-aware and model-aware.

### 3.1 Query-Aware Few-Shot Prompting

Query-aware selection of training data pairs includes selecting training data pairs that are similar (e.g., semantically similar) to the input query, based on the premise that training input queries, xₜ that are very similar to the current query 102, xᵢ have outputs that inform and improve the generation of the LLM's response to the input query 102, yᵢ.

Query-Aware selection of training data pairs can be formalized by considering the problem of selecting which training examples to include in-context when doing prediction for a given input, x. For a given few-shot budget, N (where N is the number of training pairs to be included in the put context), the problem is formulated as:

$$𝒪 = {max}_{𝒮 : 𝒮 ∈ 𝒯 , \vert 𝒮 \vert = N} log p ( {y}_{i} \vert {x}_{i} , 𝒮 )$$

where (xₜ,yₜ)∈ [symbol] are selected from the training set, [symbol] , and (xᵢ,yᵢ) are the input and a corresponding desired output on test sample, i.

Note that even if yᵢ was known, optimizing the above equation for [symbol] would be generally intractable to solve exactly, as there are

$$( \begin{matrix}\vert 𝒯 \vert \\ \vert 𝒮 \vert\end{matrix} )$$

unique sets of few-shot examples to consider. For even small training sets and just a few in-context examples, this is prohibitive (e.g., 10⁸), particularly when each evaluation of p(yᵢ|xᵢ, [symbol] ) involves running one or more LLMs for one or more generation steps. In addition, yᵢ is not known and must be predicted.

Query-aware few-shot prompting addresses this issue by reformulating the problem as:

$$𝒪 \approx {𝒪}_{𝒮} = {max}_{{𝒮}_{x} : {𝒮}_{x} ∈ {𝒯}_{x} , \vert {𝒮}_{x} \vert = N} {\sum }_{{x}_{t} ∈ {𝒮}_{x}} log p ( {x}_{i} \vert {x}_{t} )$$

where [symbol] denotes the set of inputs of the selected training data pairs to utilize.

This takes the form of a standard kNN problem, with log p(xᵢ|xₜ) proportional to the kernel (similarity function) being utilized.

In this approach, the training set or a subset thereof is used as a candidate pool of examples, which is indexed into a search/retrieval system. Then, while processing a test query, the retrieval system is used to select the top N (e.g., N<=5) best-matching results from the indexed candidate pool, which are then used as the few-shot examples in the prompt for that query.

### 3.2 Model- and Query-Aware Few-Shot Prompting

The approach used by the training data selection module 108 to select the training data pairs 109 is model aware because it also selects the training data pairs based on errors that the LLM 112 made on the training data 101.

By promoting examples that the model could not predict correctly, in-context supervision of the correct mapping from training example input, xₜ to its corresponding ground-truth output, yₜ is provided. That is, the objective function described above is augmented as follows:

$$𝒪 \approx {𝒪}_{𝒮} = {max}_{{𝒮}_{x} : {𝒮}_{x} ∈ {𝒯}_{x} , \vert {𝒮}_{x} \vert = N} α {\sum }_{{x}_{t} ∈ {𝒮}_{x}} log p ( {x}_{i} \vert {x}_{t} ) + β {\sum }_{( {y}_{t} , {x}_{t} ) ∈ 𝒮} log ( 1 - {p}_{θ} ( {y}_{t} \vert {x}_{t} ) )$$

where α+β=1, without loss of generality.

The second term (which is based on the error information determined by the training data processor) promotes training data pairs where the ground-truth output has low probability of being generated by the LLM 112, prioritizing them as supervisory signals for better performance.

Together, the two terms promote both the selection of training examples with inputs are that are close to the training input, and those that have outputs with low probability under the test-time model. That is, training data pairs that have both similar input and low output probability of correct prediction under the LLM 112 will have the highest scores, and the most value as an in-context supervisory signal.

As is described above, in some examples, the processed training data 104 includes training data pairs that include an indicator of how correctly the LLM was able to predict the correct outputs based on their queries. In that case, the entire training set is considered when selecting the few shot examples as described in, where the first and second terms correspond to how probable the test-time query is given the training query (the “query-aware” portion), and how probable training answer is given the training question (the “model-aware” portion), respectively, with alpha and beta specifying the importance of the two terms. As is also described above, in other examples, only the processed training data 104 with queries that are suitably “close” to the test query will be considered, and/or only training data where the LLM 112 predictions are incorrect or the correct answer has low probability will be considered. So, to select training data pairs in a way that is both query-aware and model-aware, the training data selection module 108 performs model- and query-aware few-shot prompt selection on the training data pairs of the processed training data 104 according to the equation above, which accounts for both query similarity and informativeness to the model. In some examples, the selection includes processing the training data pairs from the processed training data 104 to determine a measure of semantic similarity between the query, xₜ of each training data pair and the input query, xᵢ 102. In some examples, the measure of semantic similarity is determined by computing a similarity measure such as cosine similarity, dot product, Euclidean distance, or another suitable similarity measure.

The training data pairs 109 and the query 102 are provided to the prompt assembly module 110, which combines the training data pairs 109 and the query 102 into a prompt in a form suitable for input to the LLM 112. One example of a suitable prompt is:

general_few_shot prompt = “
<task_description>
<optional_few_shot_introduction>
<optional_few_shot_header_1>
<task_input_label> <task_input_1>
<task_output_label> <task_output_1>
...
<optional_few_shot_header_2>
<task_input_label> <task_input_2>
<task_output_label> <task_output_2>
...
<optional_few_shot_header_k>
<task_input_label> <task_input_k>
<task_output_label> <task_output_k>
<optional_test_input_header>
<task_input_label> <task_test_input>
<task_output_label>”

where <task_description> describes the task, <optional few shot introduction> optionally introduces the few-examples, whose input-output format and patterns are to be emulated and drawn from, <task input_label> and <task_output_label> are basic labels describing what the inputs and outputs are, and <optional_test_input_header> optionally introduces the test data that is input. Note that generally there will be multiple labeled inputs, and multiple labeled outputs.

For example, in the case of the query re-writing task:

<task_description> = “Reformulate ambiguous questions, which depend
on the conversational context, into unambiguous questions that can be
correctly interpreted without the conversational context.”,
<task_input_label_1>: “Query:”, <task_input_label_2>: “Context:”,
and <task_output_label>=“Re-written Query:”, and the optional fields are
left blank.

The prompt generated by the prompt assembly module 110 is provided as input to the LLM 112, which generates the response 106.

In some examples, the LLM 112 is a commercially available or open-source large language model, such as GPT-4, Claude, PaLM, LLAMA, Mistral, or a fine-tuned variant thereof. In other examples, the LLM 112 is a proprietary model trained or fine-tuned for the specific domain or query task.

### 4 Example Applications

Examples of the above approach to few-shot prompting are provided in the context of two tasks: NL2SQL where the generative LLM model converts a natural language statement into a SQL query, and a contextual query completion task where the model is given conversational context and a user query in that context, and the model generates a “complete” query that resolves language contractions present in the original query. For example, if the context contains information about what technical sergeants do, and the current query is “What else?” the complete query would be “What else does a technical sergeant do?”

### 4.1 NL2SQL

NL2SQL is mapping natural language queries to their SQL equivalent given a database schema. Recently, generative LLMs have been used to carry out this task. In one example, the approach described above was tested using the Yale Semantic Parsing and Text-to-SQL dataset, also known as the Spider dataset. The dataset includes 10,181 human-generated natural language questions paired with their corresponding SQL queries. There are 5,693 unique SQL queries. The Spider dataset covers a wide range of domains and includes questions that require complex SQL queries involving multiple tables, joins, aggregations, and nested subqueries. This complexity poses a significant challenge for natural language understanding systems. The approach is tested using execution accuracy as the evaluation metric. The GPT-4 model was the LLM used in the test.

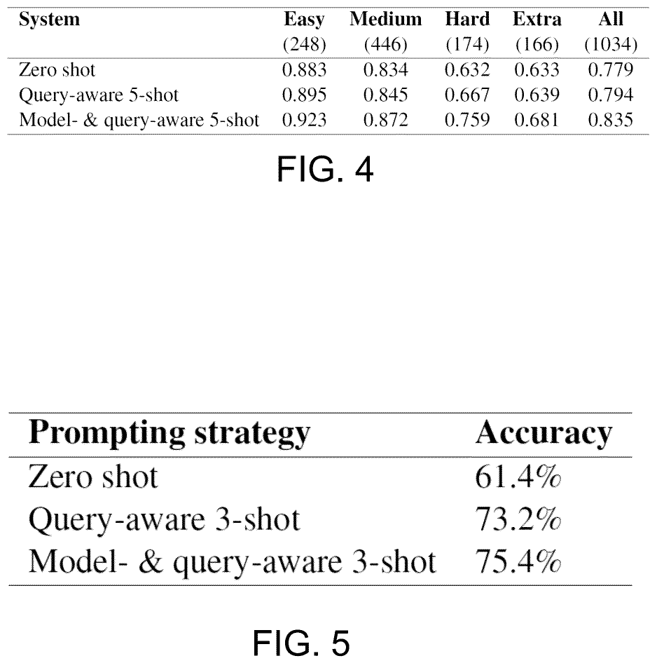

Referring to FIG. 4, a table shows the results of the baseline and the described model- and Query-aware few-shot prompting approach on the NL2SQL task. For all experiments, the results are post-processed to ensure the case of the column names in the generated query match the case in the schema.

The results indicate that across all question types (from easiest to most difficult), query-aware few-shot prompt outperformed the zero-shot approach, achieving an overall accuracy of 79.4%.

Restricting the candidate pool using our proposed model-aware approach results in a significantly higher overall accuracy of 83.5%, and this strategy consistently outperforms the query-aware approach on all question types.

Errors in evaluating NL2SQL systems arise for various reasons, including underspecified natural language queries, inherent assumptions in both model-generated and reference queries, and multiple interpretations of the data, and that the true performance of the models is underestimated. In some examples, the “Gold” correct labels are questionable. For example, for the question “What is the model of the car with the smallest amount of horsepower?” about database “car_1” GPT-4 returned the following SQL:
SELECT Model FROM car_names JOIN cars_data
ON car_names.MakeId=cars_data.Id
WHERE cars_data.Horsepower=
(SELECT MIN(cast(Horsepower as real))
FROM cars_data WHERE Horsepower!=‘na’);
   whereas the Gold SQL is:
SELECT t1.Model FROM car_names as t1
JOIN cars_data as t2 ON t1.MakeId=t2.Id
ORDER BY t2.Horsepower ASC LIMIT 1;

The Gold solution does not take into account the fact that the horsepower entry in the table is a text field and therefore is not sorted numerically, nor does it account for the fact that more than one model might have the same horsepower. The GPT-4 solution accounts for both of these issues. (Since it is not given the table entries, it does not know that missing entries are labeled ‘null’ rather than ‘na’ and would still not be correct, although that issue might be correctable by an explicit prompting instruction.)

Another example of a query which is labeled as error is for the question “What is the model for the car with a weight smaller than the average?” for which the GPT-4 hypothesis is:
SELECT t1.Model FROM model list as t1
JOIN car_names as t2 ON t1.model=12.model
JOIN cars_data as t3 ON t2.makeid=t3.id
WHERE t3.weight<
(SELECT AVG(weight) FROM cars_data);
   whereas Gold reference is
SELECT t1.Model FROM car_names as t1
JOIN cars_data as t2 ON t1.MakeId=t2.Id
WHERE t2.Weight<
(SELECT AVG(Weight) FROM cars_data)

In this case an unnecessary JOIN is performed in the GPT-4 hypothesis, causing additional repetitions in the output. Both the Gold and the Hypothesis would benefit by replacing the initial SELECT with a SELECT DISTINCT command.

Sometimes GPT-4 “over communicates” by selecting additional columns which were not requested by the query, resulting in an execution error. As an example, for the question “Which year has most number of concerts?” for the database “concert_singer” GPT-4 returns:
SELECT Year, count(*) as num_concerts FROM concert
GROUP BY Year ORDER BY num_concerts DESC LIMIT 1;
   whereas the Gold query is
SELECT Year FROM concert GROUP BY Year
ORDER BY count(*) DESC LIMIT 1

While the original question did not ask for the count, presenting that along with the year might be helpful if the result is to be presented to a human. Note that in this example, neither the GPT-4 nor the Gold accounts for the case where more than one year had the maximum number.

### 4.2 Query Expansion in Context

To test the approaches described herein on the expansion of a query based on the context provided by previous dialog turns, the OR-QuAC development dataset introduced for the Open-Retrieval Conversational Question Answering (OR-CovQA) setting is used. This dataset includes a training set of 4,383 Dialogs and 31,526 Questions. The development dataset includes 490 Dialogs and 3,430 Questions, and the test dataset is made up of 771 Dialogs and 5,571 Questions.

The first 500 questions from the test set were used as the query completion test set. Results were evaluated using ROUGE scores and GPT-4 as a judge. GPT-4 was used to determine if the queries generated by the model with ROUGE scores below 95% were semantically equivalent to the ground truth. Results were reported using the Phi-3 model.

Referring to FIG. 5, a table shows the results of baseline and the query- and model-aware few-shot prompting approach on the query completion task. As this task has a higher zero-shot error rate than NL2SQL, the few-shot examples have more opportunity to provide clues to the LLM. Indeed, a larger relative reduction in the error rate was achieved.

### 5 Alternatives

Note that like basic few-shot prompting, the proposed methods are task agnostic, and can be applied to any task done by a few-shot capable model such as an LLM, when there is input-output data available to apply the query and model aware data selection methods described herein.

In some examples, the input-output data used may itself be generated by a model or ensemble of models, such as LLMs. In this case and more generally when the data being selected from is felt to be “noisy”, outputs with lower probability may still be prioritized, but outputs with very low probability under the model may optionally be filtered out from consideration, so that there are optionally both upper and lower thresholds considered when prioritizing data in a model-aware manner.

In some examples, the query and model aware scores associated with the proposed methods may optionally be determined based on multiple few-shot capable models such as LLMs, with statistics associated with those scores, such as the average, minimum, maximum or otherwise such “combined” scores, and/or the variance or other measures of the “spread” of such scores over the models, so as to form the basis for query and model aware selection based on ensembles of models.

In some examples, all or part of the data inputs and/our outputs of the system may be structured. For example, the data may be represented in formats such as html, markup, xml, json, or otherwise demarcated text, and multimodal data including text, figures, tables, including representations of images and video, including interpretable text translations, and raw or derived representations of multimodal data, may be input our output.

In some examples, all or part of the input data may itself be derived from a process that itself utilizes one or more LLMs and query and model aware few shot prompting, resulting in a hierarchy of such processes for determining the ultimate input-output behavior characteristics of the system.

In some examples, samples may stochastically be selected, based on one or more query and model aware few shot selection objectives described. Multiple such stochastic selections can optionally be subsequently utilized to result in a highly diversified set of responses, so for example as to ultimately produce with higher likelihood one or more outputs which are deemed sufficiently or most correct, which may then be further processed manually or automatically to identify such or other desired outputs.

In one example aspect, a method for forming a prompt for use with a large language model includes receiving an input query, generating query augmentation data relevant to the query, wherein the query augmentation data includes one or more examples of queries and respective responses, wherein the query augmentation data is selected based on the input query, wherein the selecting of the query augmentation data is further based on characteristics of the large language model, and forming the prompt by combining the input query with the query augmentation data.

The method may include receiving a response by processing the prompt using the large language model. Selecting the augmentation data based on characteristics of the large language model may include training an augmentation data selection model to identify query-response pairs according to predicted responses to the queries by the large language model. Selecting the query augmentation data may include selecting query-response pairs where the query is semantically similar to the input query.

The query augmentation data may be selected using a retriever model trained to compute similarity scores between the input query and queries in a training data set. The selecting of the query augmentation data may include determining a measure of semantic similarity between the input query and each query in training data pairs of a set of available training data, ranking the training data pairs based on the determined measure of semantic similarity, and selecting a predetermined number of training data pairs according to their measures of semantic similarity. The query augmentation data may include only examples for which the large language model failed to produce a correct response in a zero-shot inference setting. The selection of the query augmentation data may include identifying examples with answer formats or structures that the large language model has previously misgenerated in similar contexts (e.g., where the predicted responses deviate from the correct responses).

The large language model may be selected from the group consisting of GPT-4, Claude, PaLM, LLaMA, Mistral, and fine-tuned variants thereof. When there are multiple examples in the prompt, the examples may be selected to be distinct from each other to ensure they provide unique pieces of evidence to the large language model. The selection of the query augmentation data may be performed using an iterative process that iteratively selects a top example and recalculates an error pool from which subsequent examples are selected. Recalculating the error pool may include performing a 1-shot (or k-shot) run over the training data, taking the top example (or top k examples) into account.

### 6 Implementations

The computational resource allocation approaches described above can be implemented, for example, using a programmable computing system executing suitable software instructions or it can be implemented in suitable hardware such as a field-programmable gate array (FPGA) or in some hybrid form. For example, in a programmed approach the software may include procedures in one or more computer programs that execute on one or more programmed or programmable computing system (which may be of various architectures such as distributed, client/server, or grid) each including at least one processor, at least one data storage system (including volatile and/or non-volatile memory and/or storage elements), at least one user interface (for receiving input using at least one input device or port, and for providing output using at least one output device or port). The software may include one or more modules of a larger program, for example, that provides services related to the design, configuration, and execution of data processing graphs. The modules of the program (e.g., elements of a data processing graph) can be implemented as data structures or other organized data conforming to a data model stored in a data repository.

The software may be stored in non-transitory form, such as being embodied in a volatile or non-volatile storage medium, or any other non-transitory medium, using a physical property of the medium (e.g., surface pits and lands, magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs), dedicated, application-specific integrated circuits (ASICs), or graphics processing units GPUs (e.g., for efficient execution of large language models or other machine learning/artificial intelligence models). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. A method for forming a prompt for use with a large language model, the method comprising:
receiving an input query;
generating query augmentation data relevant to the input query,
wherein the query augmentation data includes one or more examples of queries and respective responses,
wherein the query augmentation data is selected based on the input query,
wherein the selecting of the query augmentation data is further based on characteristics of the large language model, and
forming the prompt by combining the input query with the query augmentation data.

2. The method of claim 1 further comprising receiving a response by processing the prompt using the large language model.

3. The method of claim 1 wherein selecting the augmentation data based on characteristics of the large language model includes selecting query-response pairs according to predicted responses to the queries by the large language model.

4. The method of claim 3, wherein the predicted responses are generated by executing the large language model on the query-response pairs in a zero-shot setting.

5. The method of claim 4, wherein the query-response pairs are selected based on whether the predicted responses deviate from correct responses by a threshold amount.

6. The method of claim 1 wherein selecting the query augmentation data based on the input query includes selecting query-response pairs where the query is semantically similar to the input query.

7. The method of claim 6, wherein the query augmentation data is selected using a retriever model trained to compute similarity scores between the input query and queries in a training data set.

8. The method of claim 1, wherein the selecting of the query augmentation data further comprises:
determining a measure of semantic similarity between the input query and each query in training data pairs of a set of available training data;
ranking the training data pairs based on the determined measure of semantic similarity; and
selecting a predetermined number of training data pairs according to their measures of semantic similarity.

9. The method of claim 1, wherein the query augmentation data prioritizes examples for which the large language model failed to produce a high probability for a correct response in an inference setting.

10. The method of claim 1, wherein the selection of the query augmentation data includes identifying examples with answer formats or structures that the large language model has previously misgenerated in similar contexts.

11. The method of claim 1, wherein the large language model is selected from the group consisting of GPT-4, Claude, PaLM, LLAMA, Mistral, and fine-tuned variants thereof.

12. The method of claim 1, wherein, when there are multiple examples in the prompt, the examples are selected to be distinct from each other to ensure they provide unique pieces of evidence to the large language model.

13. The method of claim 1, wherein the selection of the query augmentation data from training data is performed using an iterative process that iteratively selects a top example and recalculates an error pool from which subsequent examples are selected.

14. The method of claim 13, wherein recalculating the error pool includes performing a k-shot run over the training data, taking a top k examples into account.

15. A system for forming a prompt for use with a large language model, the system comprising:
an input for receiving an input query;
one or more processors configured to:
generate query augmentation data relevant to the input query,
wherein the query augmentation data includes one or more examples of queries and respective responses,
wherein the query augmentation data is selected based on the input query,
wherein the selecting of the query augmentation data is further based on characteristics of the large language model, and
form the prompt by combining the input query with the query augmentation data.

16. A non-transitory computer-readable medium storing instructions that, when executed by one or more processors, cause the one or more processors to perform a method for forming a prompt for use with a large language model, the method comprising:
receiving an input query;
generating query augmentation data relevant to the input query,
wherein the query augmentation data includes one or more examples of queries and respective responses,
wherein the query augmentation data is selected based on the input query,
wherein the selecting of the query augmentation data is further based on characteristics of the large language model, and
forming the prompt by combining the input query with the query augmentation data.
